(19) United States
(12) Patent Application Publication
(10) Pub. No.: US 2017/0308903 A1
(43) Pub. Date: Oct. 26, 2017

(54) SATISFACTION METRIC FOR CUSTOMER TICKETS

(71) Applicant: HEWLETT PACKARD ENTERPRISE DEVELOPMENT LP, Houston, TX (US)

(72) Inventors: Arie Agranonik, Yehud (IL); Ira Cohen, Reut (IL)

(73) Assignee: HEWLETT PACKARD ENTERPRISE DEVELOPMENT LP, Houston, TX (US)

(21) Appl. No.: 15/517,212

(22) PCT Filed: Nov. 14, 2014
(86) PCT No.: PCT/US2014/065586

§ 371 Date: Apr. 6, 2017

(51) Int. Cl. G06Q 30/00; G06N 5/04; G06Q 10/04; G06Q 10/06

(52) U.S. Cl. CPC G06Q 30/016; G06Q 10/06393; G06N 5/045; G06Q 10/04

(57) ABSTRACT

A computing device includes at least one processor and a satisfaction prediction module. The satisfaction prediction module is to generate a pruned decision tree using historical ticket data for a plurality of customer tickets, where the historical ticket data for each customer ticket includes a satisfaction metric and attribute values of the customer ticket. The satisfaction prediction module is also to generate a plurality of business rules based on the pruned decision tree, obtain at least one attribute value of an active customer ticket, and determine, based on the plurality of business rules and the at least one attribute value, a projected satisfaction metric for the active customer ticket.

### BACKGROUND

Some organizations engage in transactions to provide products or services to customers. Each transaction may involve any number of events or actions. For example, an information technology (IT) help desk may receive a request for help from a customer, and may perform one or more remedial actions to address the request. The IT help desk may use an issue tracking system to track the request.

### BRIEF DESCRIPTION OF THE DRAWINGS

Some implementations are described with respect to the following figures.

FIG. 1 is a schematic diagram of an example computing device, in accordance with some implementations.

FIG. 2 is an illustration of an example sentiment analysis operation according to some implementations.

FIG. 3 is an illustration of an example data flow according to some implementations.

FIG. 4 is a flow diagram of a process for sentiment classification in accordance with some implementations.

FIG. 5 is a flow diagram of a process for sentiment classification in accordance with some implementations.

FIG. 6 shows an example formula for generating business rules according to some implementations.

FIG. 7 shows an example formula for filtering business rules according to some implementations.

FIG. 8 shows an example algorithm for generating business rules in accordance with some implementations.

### DETAILED DESCRIPTION

Some organizations may use customer ticket software to track interactions with customers. For example, an information technology (IT) help desk may open a customer ticket when a request for help is received from a customer. The IT help desk may update the customer ticket to store information associated with the support ticket, such as events, communications, personnel, notes, etc. Further, the IT help desk can use the customer ticket to track and coordinate the response to the request. In addition, upon completing the request, the IT help desk can analyze the customer ticket information to determine how to improve the service provided to customers. Other examples of customer tickets can include an information request, a sales transaction, a service request, etc. However, during the active lifespan of a ticket, it can be difficult to determine whether the customer is satisfied with the interaction represented by the ticket. As such, it can be difficult to prioritize tickets according to possible impact to customer satisfaction. Further, upon completion of a ticket with negative customer satisfaction, it can be difficult to determine what aspect(s) of the ticket resulted in the negative customer satisfaction, and thus it is hard to determine where and how to improve.

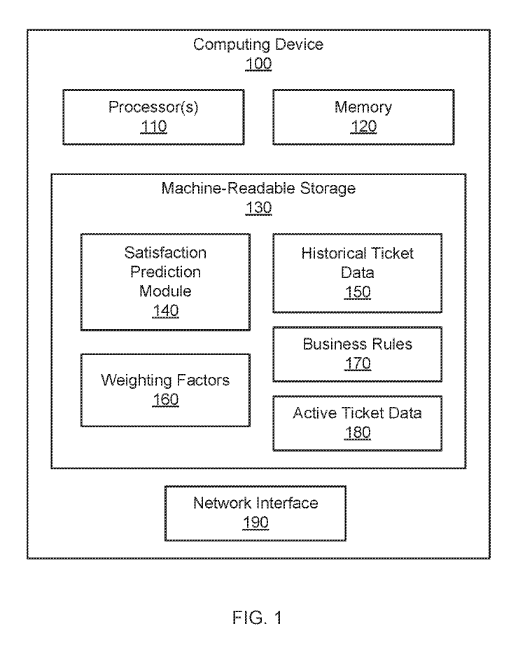

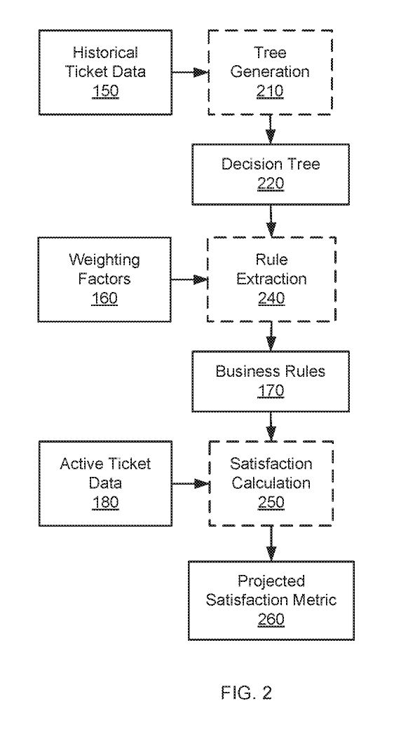

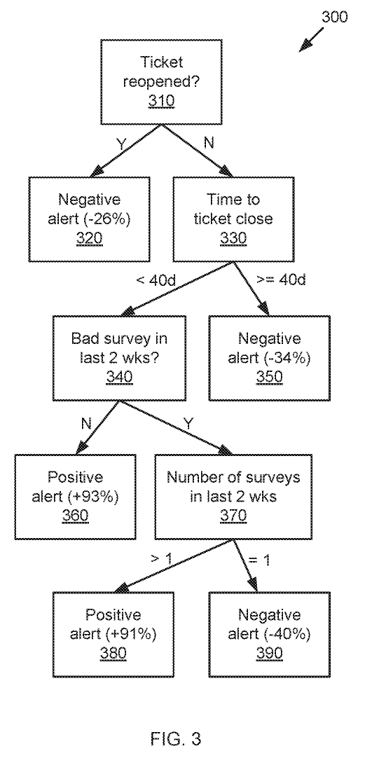

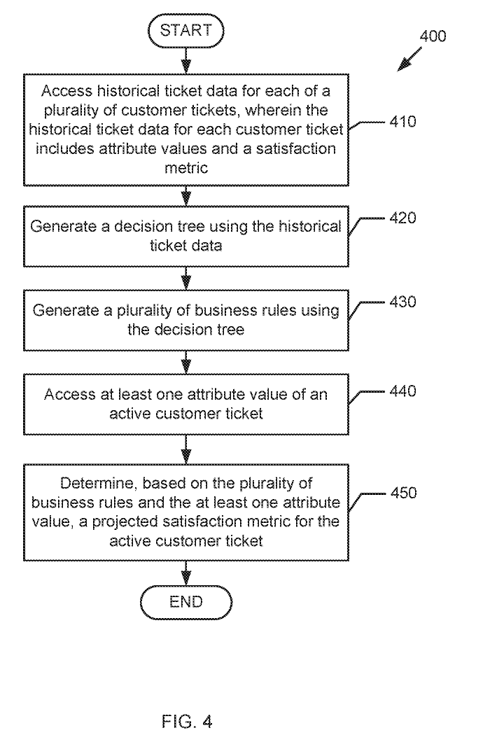

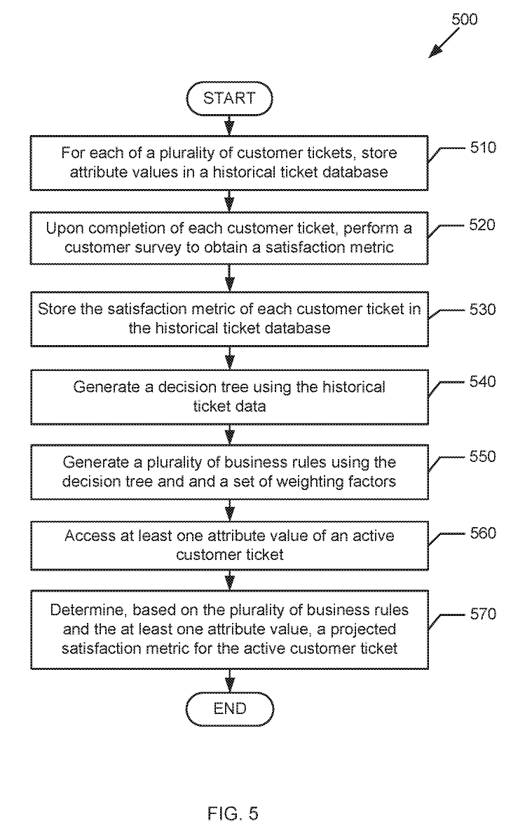

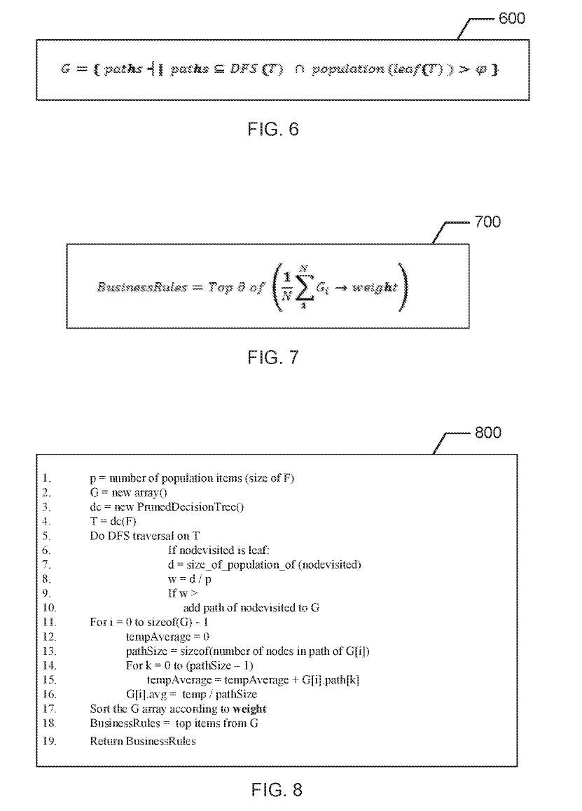

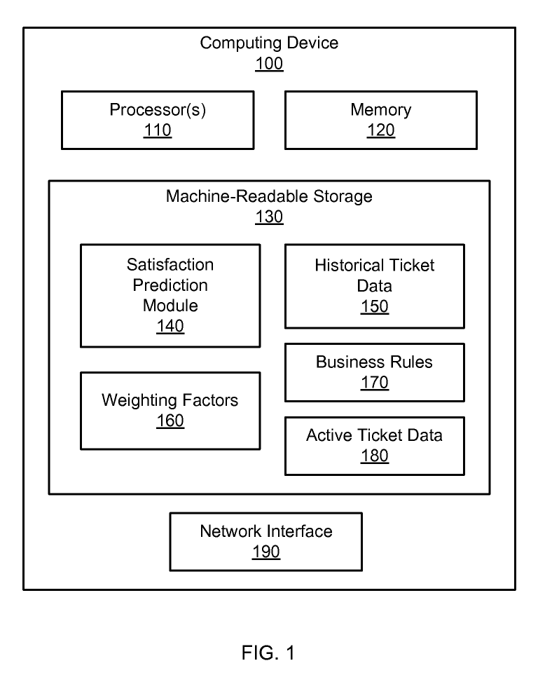

In accordance with some implementations, techniques or mechanisms are provided for estimating satisfaction metrics for customer tickets. As described further below with reference to FIGS. 1-5, some implementations may include performing satisfaction surveys upon completing tickets. The completed tickets can be analyzed to generate a decision tree. The decision tree may be analyzed to generate a set of business rules. The attributes of an active ticket may be evaluated using the business rules, thereby providing an estimated satisfaction metric for the active ticket. The estimated satisfaction metric may be used to identify potential problems with the active ticket, and may be used to prioritize and address such potential problems while the ticket is still open. As such, some implementations may provide improved customer satisfaction for tickets.

FIG. 1 is a schematic diagram of an example computing device 100, in accordance with some implementations. The computing device 100 may be, for example, a computer, a portable device, a server, a network device, a communication device, etc. Further, the computing device 100 may be any grouping of related or interconnected devices, such as a blade server, a computing cluster, and the like. Furthermore, in some implementations, the computing device 100 may be a dedicated device for estimating customer satisfaction in a ticketing system.

As shown, the computing device 100 can include processor(s) 110, memory 120, machine-readable storage 130, and a network interface 130. The processor(s) 110 can include a microprocessor, microcontroller, processor module or subsystem, programmable integrated circuit, programmable gate array, multiple processors, a microprocessor including multiple processing cores, or another control or computing device. The memory 120 can be any type of computer memory (e.g., dynamic random access memory (DRAM), static random-access memory (SRAM), etc.).

The network interface 190 can provide inbound and outbound network communication. The network interface 190 can use any network standard or protocol (e.g., Ethernet, Fibre Channel, Fibre Channel over Ethernet (FCoE), Internet Small Computer System Interface (iSCSI), a wireless network standard or protocol, etc.).

In some implementations, the computing device 100 can interface with a customer ticket system (not shown) a via the network interface 190. In other implementations, the customer ticket system can be included in the computing device 100. Further, the computing device 100 can interface with communications systems such as email, voice mail, messaging, video conferencing, etc.

In some implementations, the machine-readable storage 130 can include non-transitory storage media such as hard drives, flash storage, optical disks, etc. As shown, the machine-readable storage 130 can include a satisfaction prediction module 140, historical ticket data 150, weighting factors 160, business rules 170, and active ticket data 180.

In some implementations, the satisfaction prediction module 140 can monitor the progress of each active customer ticket, and can determine whether specific features are associated with the customer ticket. The features associated with a customer ticket can be described by attributes. The value of each attribute may indicate whether a unique feature of a set of features is associated with a particular customer ticket. For example, ticket attributes can include a ticket status (e.g., opened, closed, in progress, awaiting customer, etc.), a ticket type, a ticket milestone (e.g., stage 1 completed, stage 2 in progress, etc.), an event (e.g., a customer-initiated call, an escalation, ticket reopened, etc.). a priority (e.g., low, medium, high, urgent, etc.), a Service Level Agreement status, a customer account/name, a product identifier, and so forth. In addition, ticket attributes can include any number or type of metrics, such as number of personnel that worked on the ticket, number of internal groups that have been involved, number of tickets opened/closed on this account/product in the past N days, number of tickets closed on this account/product with survey in the past N days, number of tickets closed on this account/product with bad survey in the past N days, number of tickets opened/closed on this account/product with high urgency in the past N days, number of sequential updates from customer in an external journal, number of times the customer was informed of an update to the ticket with no response, size of activity journal between customer and personnel, and so forth.

In some implementations, the satisfaction prediction module 140 can determine a sentiment feature for a customer ticket. For example, the satisfaction prediction module 140 may perform a sentiment analysis based on the presence of words indicating positive or negative sentiments in any text (e.g., a customer email) associated with the ticket. In another example, the satisfaction prediction module 140 may perform a sentiment analysis based on the words, tone, and/or inflection in any audio information (e.g., a voice mail, an audio/video support call, etc.) associated with the ticket. The sentiment estimate can be indicated by an attribute value associated with the customer ticket.

In some implementations, a customer survey may be performed upon completion of a customer ticket. The satisfaction prediction module 140 can obtain a satisfaction metric from the customer survey. The satisfaction metric may be, for example, a qualitative value (high/medium/low, satisfied/unsatisfied, etc.) or a quantitative value (e.g., 1-10, 0-100%, etc.).

The satisfaction prediction module 140 can store attribute values associated with customer tickets in the historical ticket data 150. Further, the satisfaction prediction module 140 can store satisfaction metrics associated with customer tickets in the historical ticket data 150. The historical ticket data 150 may be a database, a flat file, or any other data structure. In some implementations, the historical ticket data 150 may be based on data fields and/or metadata associated with customer tickets. For example, the satisfaction prediction module 140 may generate and/or update the historical ticket data 150 using database fields and/or metadata accessed from a customer ticketing system (not shown).

In some implementations, each customer ticket feature may be associated with one of the weighting factors 160. The weighting factors 160 may be set by a user to indicate the relative importance or business value of each feature in comparison to other features.

In some implementations, the satisfaction prediction module 140 can generate a decision tree based on the historical ticket data 150. The decision tree may classify the historical ticket data 150 as training examples, with leaves representing classes and branches representing conjunctions of features associated with specific classes. For example, the satisfaction prediction module 140 may generate a decision tree using the C4.5 algorithm, the Classification And Regression Tree (CART) algorithm, the CHi-squared Automatic Interaction Detector (CHAID) algorithm, and so forth. Some decision tree algorithms may, at each node of the tree, select the data attribute that most effectively splits the data into classes.

In some implementations, the satisfaction prediction module 140 can “prune” the decision tree, meaning to reduce the size of the decision tree by removing sections that do not significantly add to the classification ability of the decision tree. For example, the satisfaction prediction module 140 may prune the decision tree using a Reduced Error Pruning algorithm, a Cost Complexity Pruning algorithm, and so forth.

In some implementations, the satisfaction prediction module 140 can generate the business rules 170 based on the decision tree. For example, the satisfaction prediction module 140 may perform a depth-first search of all nodes of a pruned decision tree. Upon encountering a leaf node, the satisfaction prediction module 140 may determine whether the size represented by the leaf node exceeds a first threshold. If so, the satisfaction prediction module 140 may generate a business rule based on a path from the root node to the leaf node. In some implementations, the satisfaction prediction module 140 can determine an average of the weighting factors 160 that are associated with a business rule, and may drop any business rule with an average below a defined threshold.

The satisfaction prediction module 140 can use the business rules 170 to estimate a satisfaction metric for an active ticket (i.e., a ticket currently in progress). For example, the satisfaction prediction module 140 may access feature information for an active customer ticket from the active ticket data 180. The satisfaction prediction module 140 may evaluate the business rules 170 using the feature information for the active customer ticket, and may thereby determine a projected satisfaction metric for the active customer ticket.

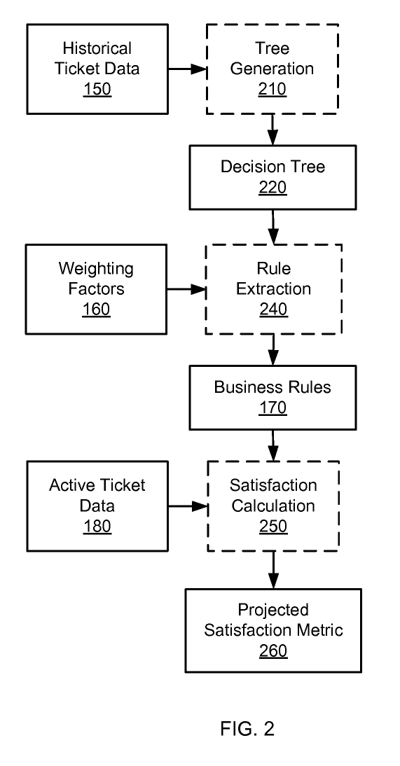

Various aspects of the satisfaction prediction module 140 are discussed further below with reference to FIGS. 2-8. Note that any of these aspects can be implemented in any suitable manner. For example, the satisfaction prediction module 140 can be hard-coded as circuitry included in the processor(s) 110 and/or the computing device 100. In other examples, the satisfaction prediction module 140 can be implemented as machine-readable instructions included in the machine-readable storage 130.

Referring now to FIG. 2, shown is an illustration of an example satisfaction estimation operation according to some implementations. As shown, a tree generation 210 may use the historical ticket data 150 to generate a decision tree 220. For example, the tree generation 210 may involve performing the C4.5 algorithm using the historical ticket data 150 as training data, thereby generating the decision tree 220. In some implementations, the decision tree 220 may be pruned. The historical ticket data 150 may include attribute values associated with features of completed tickets. Further, the historical ticket data 150 may include satisfaction metrics associated with completed tickets.

A rule extraction 240 may use the decision tree 220 and the weighting factors 160 to obtain the business rules 170. For example, the rule extraction 240 may involve a depth-first search of the decision tree 220. Each business rule 170 may be based on a path from a root node to a leaf node. In some implementations, the business rules 170 may be limited to paths having a minimum node population (i.e., paths including a number of nodes greater than a defined threshold). Further, the business rules 170 may be limited to those paths having average weighting factors 160 that meet a defined threshold.

A satisfaction calculation 250 may use the business rules 170 and the active ticket data 180 to obtain a projected satisfaction metric 260. For example, the satisfaction calculation 250 may evaluate the business rules 170 using attribute values of a particular active ticket. The projected satisfaction metric 260 may indicate whether the particular active ticket is estimated to result in an unsatisfactory outcome when completed.

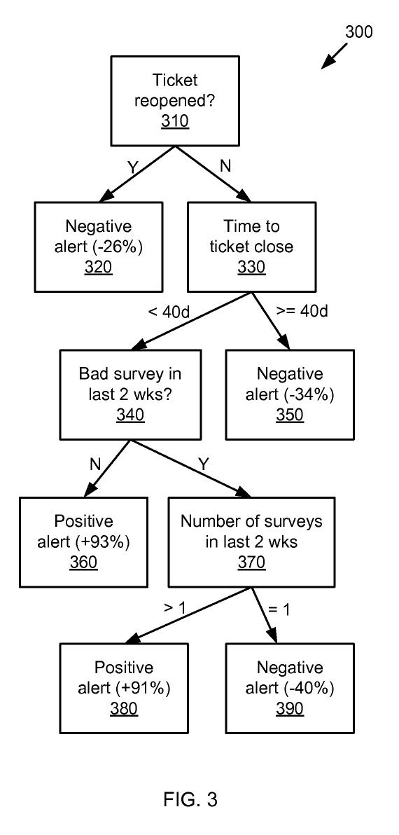

Referring now to FIG. 3, shown is an illustration of an example decision tree 300 according to some implementations. The decision tree 300 may be generated by a statistical classification algorithm using training data (e.g., historical ticket data 150). The decision tree 300 includes various nodes, with each internal node (i.e., a non-leaf node) representing a test on an attribute, each branch representing an outcome of a test, and each leaf node representing a class label.

As shown in FIG. 3, the topmost node in the decision tree 300 is the root node 310, corresponding to a “ticket reopened” attribute. If the “ticket reopened” attribute is set to a “Yes” value, then a negative alert of a −26% customer satisfaction impact is indicated at leaf node 320. However, if “ticket reopened” attribute is set to “No,” then a “time to ticket close” attribute is represented by node 330.

If the “time to ticket close” attribute is greater than or equal to forty days, then a negative alert of a −34% customer satisfaction impact is indicated at leaf node 350. However, if the “time to ticket close” attribute is less than forty days, then a “previous bad survey” attribute is represented by node 340.

As shown, if the “bad survey in last 2 weeks” attribute is set to “Yes,” then a positive alert of a +93% customer satisfaction impact is indicated at leaf node 360. However, if the “bad survey in last 2 weeks” attribute is set to “No,” then a “number of bad surveys” attribute is represented by node 370.

If the “number of surveys in last 2 weeks” attribute is greater than 1, then a positive alert of a +91% customer satisfaction impact is indicated at leaf node 380. However, if the “number of surveys in last 2 weeks” attribute is equal to 1, then a negative alert of a −40% customer satisfaction impact is indicated at leaf node 390.

In some implementations, the paths included in the decision tree 300 may be used to generate a set of business rules. For example, the path from root node 310 to leaf node 320 may be used to generate a business rule stating “if a ticket is reopened, there is a 26% chance of negative satisfaction for the ticket.” In addition, the path from root node 310 to leaf node 350 may be used to generate a business rule stating “if a ticket is not reopened and the time to closure is more than 40 days, there is a 34% chance of negative satisfaction for the ticket.” Further, the path from root node 310 to leaf node 360 may be used to generate a business rule stating “if a ticket is reopened, and the time to closure is less than 40 days, and there are no negative surveys in the last two weeks, then there is a 93% chance of positive satisfaction for the ticket.” Further, the path from root node 310 to leaf node 380 may be used to generate a business rule stating “if a ticket is reopened, and the time to closure is less than 40 days, and there are no negative surveys in the last two weeks, and the number of surveys in the last two weeks greater than one, then there is a 91% chance of positive satisfaction for the ticket.” Further, the path from root node 310 to leaf node 390 may be used to generate a business rule stating “if a ticket is reopened, and the time to closure is less than 40 days, and there are no negative surveys in the last two weeks, and the number of surveys in the last two weeks is one, then there is a 40% chance of negative satisfaction for the ticket.”

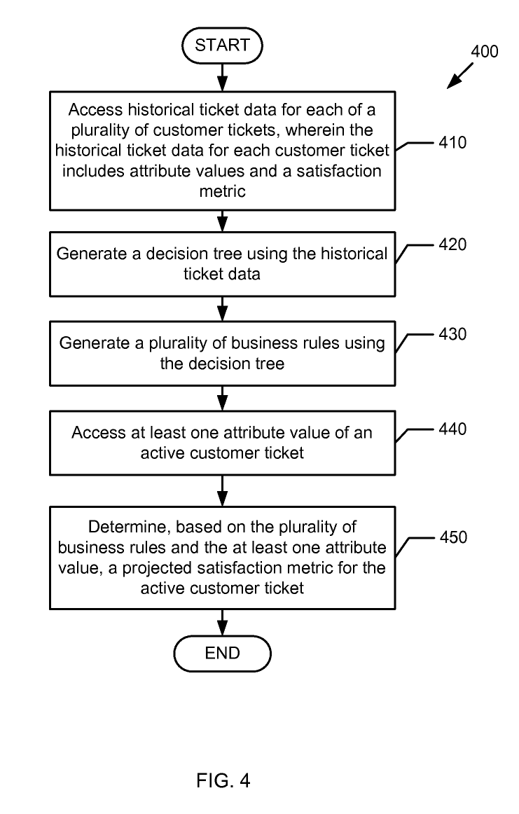

Referring now to FIG. 4, shown is a process 400 for estimating customer satisfaction in accordance with some implementations. The process 400 may be performed by the processor(s) 110 and/or the satisfaction prediction module 140 shown in FIG. 1. The process 400 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 400 may be described below with reference to FIGS. 1-3, which show examples in accordance with some implementations. However, other implementations are also possible.

At 410, historical ticket data for each of a plurality of customer tickets may be accessed. In some implementations, the historical ticket data for each customer ticket may include attribute values and a satisfaction metric associated with the customer ticket. For example, referring to FIG. 1, the satisfaction prediction module 140 may access the historical ticket data 150, including attribute values and satisfaction metrics for previously completed customer tickets.

At 420, a decision tree may be generated using the historical ticket data. For example, referring to FIGS. 1-3, the satisfaction prediction module 140 may perform a decision tree classification algorithm (e.g., C4.5, CART, CHAID, etc.) on the historical ticket data 150 to generate the decision tree 300. Further, in the decision tree 300, each internal node can represent a test on an attribute, each branch can represent an outcome of a test, and each leaf node can represent a class label. In some implementations, the satisfaction prediction module 140 may also prune the decision tree 300.

At 430, a plurality of business rules may be generated using the decision tree. For example, referring to FIGS. 1-3, the satisfaction prediction module 140 may extract the business rules 170 based on the paths included in the decision tree 300. In some implementations, the business rules 170 can also be based on the weighting factors 160 associated with paths of the decision tree 300. Further, the business rules 170 may be based on the number of nodes included in a path.

At 440, at least one attribute value of an active customer ticket may be accessed. For example, referring to FIGS. 1-3, the satisfaction prediction module 140 may receive a request to determine an estimated customer satisfaction for an active customer ticket. In some implementations, the request may include (or may reference) attributes values associated with the active customer ticket (e.g., a priority attribute value, a “number of calls” attribute value, etc.).

At 450, a projected satisfaction metric for the active customer ticket may be determined based on the plurality of business rules and the at least one attribute value. For example, referring to FIGS. 1-3, the satisfaction prediction module 140 may evaluate the business rules 170 using the attribute values associated with the active customer ticket, thereby obtaining an estimate of the customer satisfaction for the active customer ticket based on current information. In some implementations, the estimated customer satisfaction may be used to determine a priority for the active customer ticket, whether to take additional actions for the active customer ticket, and so forth. After 450, the process 400 is completed.

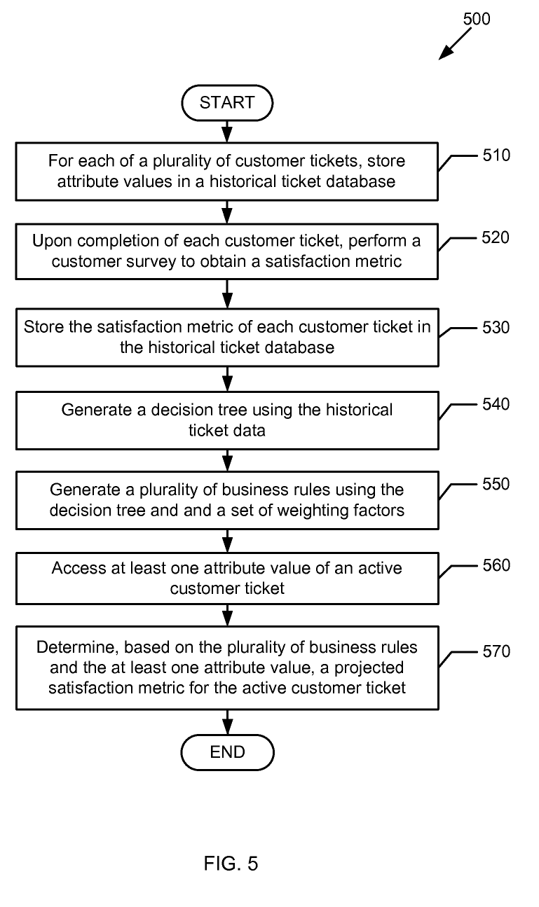

Referring now to FIG. 5, shown is a process 500 for estimating customer satisfaction in accordance with some implementations. The process 500 may be performed by the processor(s) 110 and/or the satisfaction prediction module 140 shown in FIG. 1. The process 400 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 500 may be described below with reference to FIGS. 1-3, which show examples in accordance with some implementations. However, other implementations are also possible.

At 510, attribute values of each of a plurality of customer tickets may be stored in a historical ticket database. For example, referring to FIG. 1, the satisfaction prediction module 140 may collect information about attributes of customer tickets, and may store the attribute information of each customer ticket in the historical ticket data 150. In some implementations, the information about attributes may be accessed from data fields and/or metadata associated with customer tickets.

At 520, upon completing each customer ticket, a customer survey may be performed to obtain a satisfaction metric. For example, referring to FIG. 1, the satisfaction prediction module 140 may initiate a customer survey in response to the completion of a customer ticket. The customer survey may be, e.g., an automated telephone survey, a text-based automated survey, a telephone interview conducted by a human, an email questionnaire, and so forth.

At 530, the satisfaction metric provided by the customer survey for each customer ticket may be stored in the historical ticket database. For example, referring to FIG. 1, the satisfaction prediction module 140 may store the customer survey results of each completed customer ticket may be stored in the historical ticket data 150.

At 540, a decision tree may be generated using the historical ticket data. For example, referring to FIGS. 1-3, the satisfaction prediction module 140 may analyze a portion (or all) of the historical ticket data 150 using a decision tree classification algorithm to generate the decision tree 300. In some implementations, the satisfaction prediction module 140 may prune the decision tree 300.

At 550, a plurality of business rules may be generated using the decision tree and a set of weighting factors. For example, referring to FIGS. 1-3, the satisfaction prediction module 140 may extract the business rules 170 based on the paths included in the decision tree 300. The satisfaction prediction module 140 may evaluate the average of the weighting factors 160 associated with paths of the decision tree 300. Further, the satisfaction prediction module 140 may drop any business rules having an average of weighting factors 160 that is less than a first threshold. Furthermore, the satisfaction prediction module 140 may drop any business rules associated with a node population (i.e., the number of nodes in the associated path) below a second threshold.

At 560, at least one attribute value of an active customer ticket may be accessed. For example, referring to FIGS. 1-3, the satisfaction prediction module 140 may receive a request including an attribute value of an active customer ticket.

At 570, a projected satisfaction metric for the active customer ticket may be determined based on the plurality of business rules and the at least one attribute value. For example, referring to FIGS. 1-3, the satisfaction prediction module 140 may evaluate the business rules 170 using the attribute value associated with the active customer ticket, thereby obtaining an estimate of the customer satisfaction for the active customer ticket based on current information. After 570, the process 500 is completed.

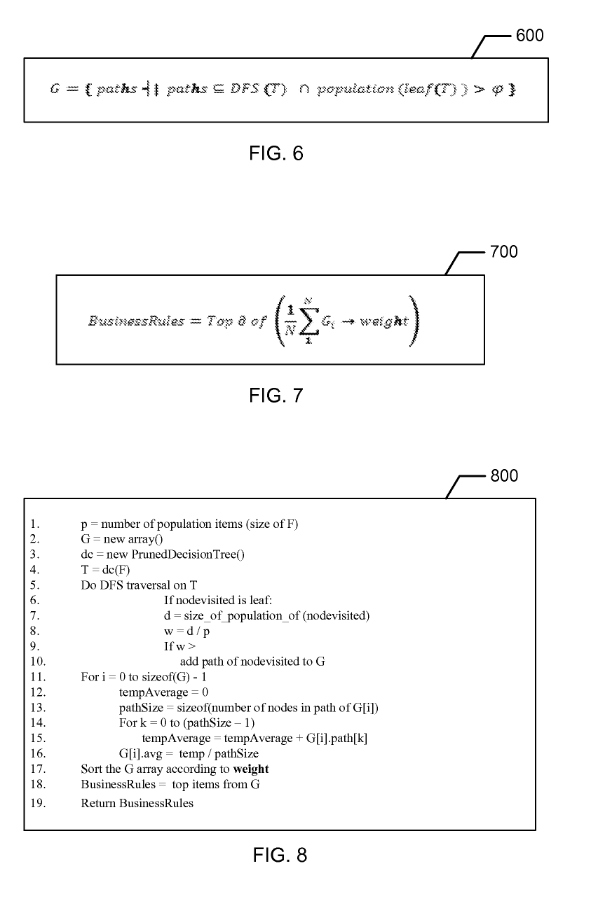

Referring now to FIG. 6, shown is an example formula 600 for generating business rules according to some implementations. In some implementations, the formula 600 may be included in (or performed by) the satisfaction prediction module 140 (shown in FIG. 1). As shown, the formula 600 extracts an array G of those paths of a decision tree in which the population represented by the path is larger than a threshold population variable φ. In some implementations, the threshold population variable φ is a parameter that cuts irrelevant paths associated with small node populations (i.e., number of nodes in path).

Referring now to FIG. 7, shown is an example formula 700 for filtering business rules according to some implementations. In some implementations, the formula 700 may be included in (or performed by) the satisfaction prediction module 140 (shown in FIG. 1). As shown, the formula 700 extracts a set of business rules by averaging the weights of each path and taking the top δ paths. In some implementations, the variable δ sets the maximum number of rules to produce, and may be adjusted to exclude business rules that are not sufficiently relevant.

Referring now to FIG. 8, shown is an example algorithm 800 for generating business rules in accordance with some implementations. In some implementations, the algorithm 800 receives an input F, representing a set of features of customer tickets that form the basis of a decision tree. Further, the algorithm 800 can receive an input M, representing an array of weighting factors. Each feature included in the feature set F may be associated with a corresponding weighting factor in array M.

In some implementations, lines 1-4 of the algorithm 800 creates a pruned decision tree and apply it to the feature set F, and thereby produces a new decision tree data structure. At line 5, the algorithm 800 runs a Depth-First Search on the decision tree, and traverses each node of the decision tree. When the algorithm 800 encounters a leaf node, it checks the size of the population it represents. At lines 6-10, the algorithm 800 determines if the size of the population represented by the leaf node is higher than the threshold population variable φ, and if so, creates a business rule based on the path to the leaf node. At lines 11-18, the algorithm 800 sorts the business rules according to the average of weighting factors of the features in each path, and saves only the top δ business rules in a stored set of business rules.

In accordance with some implementations, a customer satisfaction algorithm may produce business rules using collected behavioral and textual features of the ticketing system. The business rules may be used to estimate customer satisfaction metrics for active tickets. As such, some implementations may enable potential problems with the active ticket to be identified. Further, active tickets may be prioritized to address potential problems while the ticket is still open. Accordingly, some implementations may provide improved customer satisfaction for tickets.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A computing device comprising:
at least one hardware processor;
a satisfaction prediction module executable by the at least one hardware processor to:
generate a pruned decision tree using historical ticket data for a plurality of customer tickets, wherein the historical ticket data for each customer ticket includes a satisfaction metric and attribute values of the customer ticket;
generate a plurality of business rules based on the pruned decision tree;
access at least one attribute value of an active customer ticket; and
determine, based on the plurality of business rules and the at least one attribute value, a projected satisfaction metric for the active customer ticket.

2. The computing device of claim 1, the satisfaction prediction module further to:
for each customer ticket of the plurality of customer tickets, store the attribute values of the customer ticket in the historical ticket data for the customer ticket.

3. The computing device of claim 1, the satisfaction prediction module further to:
upon completion of each customer ticket of the plurality of customer tickets, obtain, based on a customer survey, a satisfaction metric for the customer ticket; and
store the satisfaction metric in the historical ticket data for the customer ticket.

4. The computing device of claim 1, wherein each of the attribute values indicates whether a unique feature of a plurality of features is associated with a particular customer ticket, wherein each feature of the plurality of features comprises at least one of a ticket status, a ticket milestone, a ticket event, a ticket metric, a ticket priority, and a customer attribute.

5. The computing device of claim 4, wherein the satisfaction prediction module is to generate the plurality of business rules based at least in part on a plurality of weighting factors, wherein each of the plurality of weighting factors is associated with a unique feature of the plurality of features.

6. The computing device of claim 1, wherein the satisfaction prediction module is further to:
perform a depth-first search of all nodes of the pruned decision tree;
in response to encountering a leaf node of the pruned decision tree:
determine a node population in a path from a root node to the leaf node;
determine whether the node population in the path exceeds a first threshold; and
in response to a determination the node population in the path exceeds the first threshold, add a new business rule to the plurality of business rules, wherein the new business rule is generated based on the path from the root node to the leaf node.

7. The computing device of claim 1, wherein each customer ticket is to track information associated with a unique customer transaction.

8. A method comprising:
accessing historical ticket data for each of a plurality of customer tickets, wherein the historical ticket data for each customer ticket includes a satisfaction metric and attribute values of the customer ticket;
generating, using at least one hardware processor, a decision tree using the historical ticket data;
pruning, using the at least one hardware processor, the decision tree to generate a pruned decision tree;
generating, using the at least one hardware processor, a plurality of business rules using the pruned decision tree;
accessing at least one attribute value of an active customer ticket; and
determining, based on the plurality of business rules and the at least one attribute value, a projected satisfaction metric for the active customer ticket.

9. The method of claim 8, further comprising:
for each customer ticket of the plurality of customer tickets:
storing the attribute values of the customer ticket in the historical ticket data for the customer ticket;
upon completion of the customer ticket, performing a customer survey to obtain a satisfaction metric for the customer ticket; and
storing the satisfaction metric in the historical ticket data for the customer ticket.

10. The method of claim 8, wherein each of the attribute values indicates whether a unique feature of a plurality of features is associated with a particular customer ticket, wherein each feature of the plurality of features is associated with a unique weighting factor, and wherein generating the plurality of business rules is based at least in part on the unique weighting factor associated with each feature of the plurality of features.

11. The method of claim 8, wherein generating the plurality of business rules comprises:
traversing each node of the pruned decision tree;
in response to encountering a leaf node of the pruned decision tree:
determining a node population in a path from a root node to the leaf node;
determining whether the node population in the path exceeds a first threshold; and
in response to a determination the node population in the path exceeds the first threshold, generating a new business rule based on the path from the root node to the leaf node.

12. An article comprising at least one non-transitory machine-readable storage medium storing instructions that upon execution cause at least one hardware processor to:
generate a pruned decision tree using historical ticket data for a plurality of customer tickets, wherein the historical ticket data for each customer ticket includes a satisfaction metric and information about features associated with the customer ticket;
for each customer ticket of the plurality of customer tickets, access weighting factors for the features associated with the customer ticket;
generate a plurality of business rules based on the pruned decision tree, the weighting factors, and a maximum number of rules;
access information about at least one feature associated with an active customer ticket; and
determine, based on the plurality of business rules and the information about the at least one feature associated with the active customer ticket, a projected satisfaction metric for the active customer ticket.

13. The article of claim 12, wherein the satisfaction metric for each customer ticket is based on a customer survey associated with the customer ticket.

14. The article of claim 12, wherein the instructions further cause the processor to:
determine whether a node population in a path from a root node to the leaf node exceeds a first threshold; and
in response to a determination the node population in the path exceeds the first threshold, generate a new business rule based on a set of features included in the path.

15. The article of claim 14, wherein the instructions further cause the processor to:
determine an average weight associated with each business rule of the plurality of business rules;
sort the plurality of business rules according to the average weight associated with each business rule; and
drop any business rule below the maximum number of rules.
